(19) United States
(12) Patent Application Publication
(10) Pub. No.: US 2004/0193572 A1
(43) Pub. Date: Sep. 30, 2004

(54) System and method for the management, analysis, and application of data for knowledge-based organizations

(76) Inventor: Richard M. Leary, Harlaston (GB)

Correspondence Address: SIDLEY AUSTIN BROWN & WOOD LLP, 717 NORTH HARWOOD, SUITE 3400, DALLAS, TX, 75201, US

(21) Appl. No.: 10/475,582

(22) PCT Filed: May 3, 2002
(86) PCT No.: PCT/IB02/02613

Related U.S. Application Data
(60) Provisional application No. 60/288,521, filed on May 3, 2001.

(51) Int. Cl. G06F 7/00

(52) U.S. Cl. 707/1

(57) ABSTRACT

The present invention pertains in general to the management and analysis of data through use of computers and/or network connected computer systems, with the present invention having particular applicability to the management and analysis of computer data to identify links, patterns and networks of associations to discover trends, determine suspects and/or predict threats in the fields of law enforcement and airline security.

### TECHNICAL FIELD OF THE INVENTION

The present invention pertains in general to the management and analysis of data through use of computers and/or network connected computer systems, with the present invention having particular applicability to the management and analysis of computer data to identify links, patterns and networks of associations to discover trends, determine suspects and/or predict threats in the fields of law enforcement and airline security.

### BACKGROUND OF THE INVENTION

Every organization, whether in the public or private sector, has to some extent a need to manage information. However, some organizations exist in whole or in part to manage information as a core element of their business activity. Examples of these organizations who have a specific responsibility in maintaining and using data are law enforcement agencies, government departments, health organizations, and insurance companies. These, and other organizations, which can be generally characterized as “knowledge-based organizations”, are charged with the responsibility of managing a variety of forms of data for a variety of purposes as part of their everyday business activity.

One common function among knowledge-based organizations is the need to manage and analyze complex data to facilitate decision-making and to maintain an effective service free of fraud and crime. For example, in a law enforcement context, management and analyses involves making sense out of masses of evidence having many forms and existing in various recurrent combinations. The present invention provides a means to identify links, patterns and networks of associations to discover knowledge and trends and to predict threats to an organization and its clients.

The present invention also addresses the fundamental problems encountered in the management, analysis, synthesis and application of data for knowledge based organizations, which include:

1. Mixed masses of information to manage,

2. The doubtful relevance, credibility and value of the data,

3. Drawing useful, defensible and predictive conclusions from the masses of information available to knowledge-based organizations, and

4. The lack of an effective and systematic method management, analyses and synthesis of data.

### SUMMARY OF THE INVENTION

A selected embodiment of the invention is a computer-based information management and analysis system which includes a computer, a database wherein multiple sources of evidence is stored, and means to display relationships between the stored evidence and an event. In a preferred embodiment of the invention, the multiple sources of stored evidence are forensic sources of evidence. In yet another preferred embodiment of the invention, the relationships being displayed are criminal events.

Another selected embodiment of the present invention provides a method of managing and analyzing evidence comprising the steps of (a) inputting a multiple of independent evidentiary links, (b) identifying a relationship between at least one of the multiple of independent evidentiary links and an event; and (c) displaying the relationship. In a preferred aspect of this selected embodiment, the multiple evidentiary input comprises forensic evidence. In yet a another aspect of this selected embodiment of the invention, the event is a criminal event.

### BRIEF DESCRIPTION OF THE DRAWINGS

For a more complete understanding of the present invention, reference is now made to the following detailed description taken in conjunction with the drawings in which:

FIG. 1 is a diagram illustrating the methodology of the present invention in a criminal law enforcement application.

### DETAILED DESCRIPTION OF THE INVENTION

The present invention relates to a method and system for managing and analyzing information and generating tables, charts and other visual displays of information showing links and trends between and among the input data. Preferably, these systems are accessible by multiple users for analyzing information and generating such visual displays.

For a more complete understanding of the system and method of the present invention, the core principles underpinning the subject invention shall be discussed first, followed by a representative application of the inventive system and methodology in the field of law enforcement and investigation.

The five (5) key principles that underpin the present system and methodology are:

1. How well an organization systemizes, manage and marshals the data it currently possesses influences how well it will be able to discover information it does not possess but ought to possess.

2. Making effective use of data involves the use of systemized strategies for inquiry and search not just search alone.

3. Strategic and systematic use of deductive, inductive and abductive reasoning.

4. Every instance of exploration and discovery occurs over time and is unique. Different inferential requisites emerge at different times and in different combinations therefore no one strategy will suffice for every situation or circumstance.

5. The generation of new ideas in fact investigation usually rests upon marshalling or juxtaposing thought and evidence in different ways.

For illustrative purposes, the methodology and system of the present invention will be described in the context of three applications: (A) law enforcement crime investigation, (B) an investigative system and method of identifying “unknown” offenders, and (C) airport security.

A. First Illustraive Embodiment—Criminal Law Enforcement

The traditional approach to evidence and intelligence management in law enforcement globally is based on: —

1. The investigation of single cases—one crime at any one time and on a case-by-case basis. All the evidence and intelligence in one case is gathered and used with regard to that case alone; and

2. Evidence and intelligence is viewed largely on the basis of what it is (e.g., DNA, fingerprints, informants, witnesses, footprints, handwriting, ballistics, etc.) rather than what it can tell you. What is missed is the advantages that can be gained by describing the evidence by what it can tell you not what it is.

The methodology and system of the present invention is relatively unconcerned with the source of the evidence, the criminals involved and the crimes they have committed. Instead, it draws on the mass of data about multiple crimes, multiple criminals and multiple evidence types to allow networks and patterns to be discovered and displayed pictorially using the diversity of data available to develop the links and patterns. The patterns and graphical interfaces can be analyzed, researched and juxtaposed in a number of ways. It is by juxtaposing the information that provides insights into the many and varied patterns and relationships that exist within the data. By virtue of the vast numbers of crimes, criminals and evidence and intelligence sources involved, a computer or computer network is used to store, retrieve and present the data in the form of networks and links. Preferably, executable software is employed in order to facilitate the discovery of links between data items about people, crimes, events, locations and times and then present that information in a graphical format for visual inspection. Additional questions and searches of the system can then be undertaken based upon the new information presented by system.

The key areas the present system and methodology addresses in criminal law enforcement application are:—

1. The management of forensic and physical matches between people, crimes, events, locations and times, for example, DNA, fingerprints, footwear, handwriting, drugs, toolmarks, and ballistics.

2. The management of testimonial and intelligence assertions, for example witness perceptions about links between people, crimes, events, locations and times.

3. The management of data gained from covert and overt sensing devices, for example, closed circuit TV, tape recordings of voice and sound, pictures and sound from photography and telephone interception and other covert or overt sensing devices that recover data about people, crimes, events, locations and times of interest to the organization.

Law enforcement organizations generate enormous amounts of forensic, physical and testimonial evidence links between people, events, crimes, locations and times. They call these “matches” or “hits.” A range of evidence generation techniques is used to do this. The present invention harnesses these together in both a holistic and atomistic manner to provide a rational, empirical approach to knowledge generation. The information to be managed and analyzed generally falls into three categories: (a) forensic and physical evidence and intelligence; (b) testimonial and intelligence assertions; and (c) information gathered by covert and overt sensing devices. In accordance with the present invention, a computer and an executable computer application (i.e., program) are employed to manage, marshal, integrate and combine evidence from the three areas listed above. Physical and forensic information and evidence (e.g., DNA, fingerprints, footwear, toolmarks, handwriting, firearms and drugs information and evidence) are used as it provides information about crimes and suspected criminals and often provides matches or hits. Data derived from testimonial and intelligence assertions are used as they too provide information about crimes and suspected criminals and often provide links between events, people and evidence. Data and intelligence derived from covert and overt sensing devices are used as they typically provide information about crimes and suspected criminals and often provide links between events, people and evidence.

The table shown below illustrates the methodology of the present invention, whereby links and connections between crimes and people are made based on multiple types and/or sources of evidence input into a database and displayed in table or graphical form. In traditional practice, these links are too complex to discover using conventional approaches. As shown, the table below depicts the manner in which n suspects (people) are linked to n crime scenes and by which evidence type. This illustrative example is based on only 5 people and 5 crimes. In practice, the actual values of “n” crimes and “n” suspects will be larger and hence the potential for links is much larger.

[image]

As shown in the table, Person 1 is linked to Crimes 1, 4 and 5 by DNA, fingerprints and handwriting evidence, respectively. Person 4 is linked to Crimes 1 and 4 by footmark and toolmark evidence, respectively. However, there are more apparent patterns in this illustrative example when visually displayed in the form of a network of the links, as shown in the graphic below:—

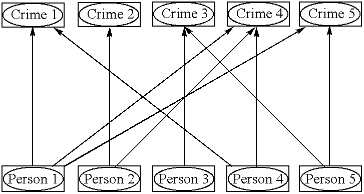

On further analysis, other patterns can be identified within the network For example those persons who are committing more than one crime is displayed in the following graphic:—

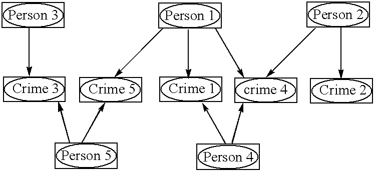

Even further analysis reveals groups or sub-networks of people operating together, as depicted in the network graphic below:—

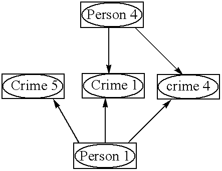

The methodology and system of the present invention uses graphical interfaces to illustrate linkages and patterns in the form of pictures or other visual displays of data. This draws on the psychological benefits for operators and analysts in being able to view and present masses of related information in user-friendly ways and formats. For example, the present system and methodology provides visual representations that show geographical distributions or crimes associated with particular suspects, timelines and/or a variety of statistical compilations useful in studying patterns of criminal activities, keeping track of the disposition of cases, and in managing investigational and analytical resources.

A further aspect of the present invention is that it provides the means to generate new information about what may at first sight be thought ancillary matters. This is accomplished by arranging the data in the system into different lists or sets by the use of predetermined “questions.” For example, by using predetermined questions associated with the database and software, the system may provide a way of generating additional understanding about crime networks based on geography, time and associations. In addition, the software application can be designed to obtain many different types of management information about the types of crimes, the types of evidence, the frequency of results, the relationship between different criminals and the geographic nature of crime.

Discovery can be called fact inquiry. Fact Inquiry is a better description since it emphasizes the crucial role of asking questions as investigations proceed and links begin to develop between people, crimes, events, locations and times. In accordance with the present invention, the system software allows the user to ask a range of questions to combine data about people, crimes, events, locations and times to produce patterns and links. After initial patterns and links are obtained and displayed through predetermined questions, the user is able to prepare new questions to search for additional patterns and links.

In the law enforcement context, predetermined questions that are provided in the software are designed to suggest “hunches” about what has happened in some episode of crime or some event or series of events. New “hunches” and hypotheses may then be developed as the investigation and analysis of facts and data proceeds and these can be used to ask further questions of the data. Thus, the present invention provides for the discovery and re-discovery of knowledge in this way. It is the “Network Manipulation and Analytical Tools” node (discussed in greater detail below) of the present invention that allows the user to engage in “Hunch” and “Hypothesis” generation activity.

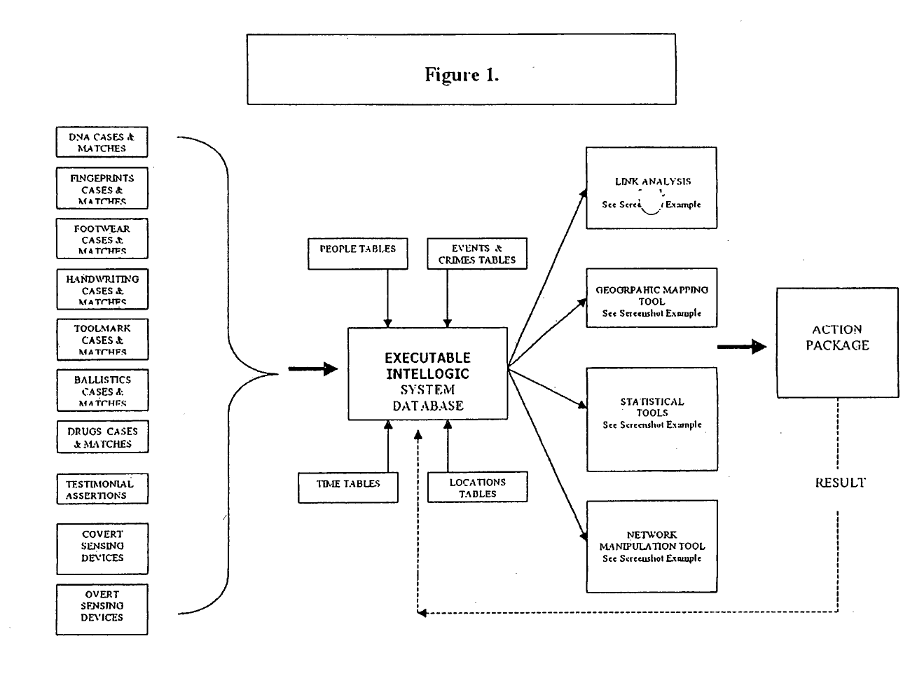

Referring to FIG. 1, an illustration of the methodology and system of the present invention, as may be applied in a criminal law enforcement context, is shown. Preferably, the methodology and system employs a computer, database and software providing the following “tools” or features, as shown in FIG. 1: a Link Analysis Tool, Graphical Mapping Tool, a Statistical Tool, and Network Manipulation Tool.

The Link Analysis Tool is a software feature designed to visualize links and connections between people, crimes, events, locations and times based upon the evidence providing the proof of the link. For example, the icons used in any executable version could be made more visually impactive. In addition, the icons (nodes) and the links (arcs) may be moved with the use of software to demonstrate dependant relationships and suggest ways in which the networks could be manipulated or attacked operationally. A representative example of this feature is shown in the screenshot below.

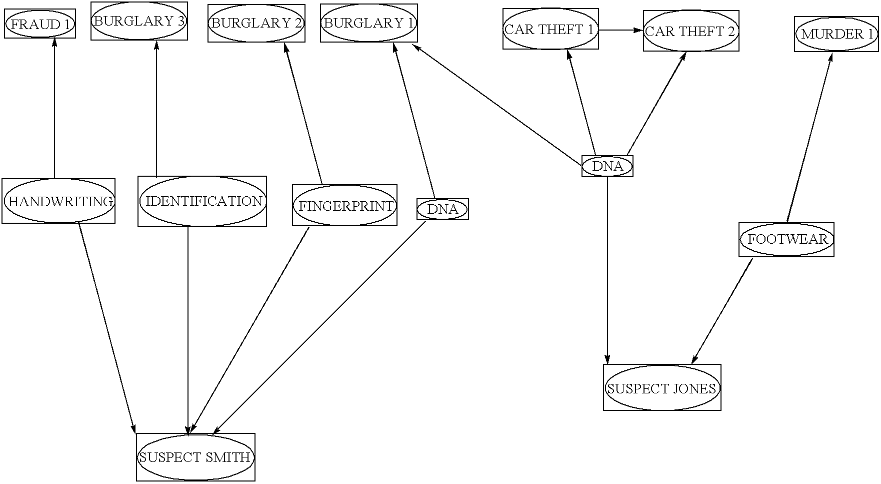

The software is preferably designed to indicate which of the nodes should be attacked and in which order to produce the most appropriate fragmentation and hence reduce the criminal network.

The Geographical Mapping Tool (FIG. 1) is a software feature designed to allow the linkages between people, crimes, events, locations and times to be mapped. A sample computer screenshot is provided below illustrating this tool. The triangles in the sample screenshot represent the crimes committed and the black circles represent the last known residence of the suspect. This feature allows for predictive “hot spot” analysis. In this illustration, the crimes (triangles) are linked to the suspect (black circles) by fingerprint and DNA matches. However, the software should be designed to allow any classifications of evidence links.

[image]

The Statistical Tools (FIG. 1) is a software feature designed to allow tables, charts and other depictions of data and statistics to be assimilated and visualized. For example, the sample screenshot below depicts statistical representation of occurrences of ballistics, DNA and fingerprint data by geographical area. Preferably, the system is configured such that access to all of the stored data is available so that software associated with this tool can generate other various charts, graphs and visual depictions of statistical information derived from the stored data. Further, it is preferable that the software associated with this tool be designed to allow standard tables to be selected for viewing at time intervals appropriate to the operation.

[image]

Still referring to FIG. 1, another feature of the preferred embodiment of the invention is a Network Analytical Tool. This tool is a software feature designed to allow the user to view visually the links from the Link Analysis Tool and then engage in exploring dependent links between various nodes and arcs. The sample screenshot below illustrates this feature of the invention. Preferably, the nodes and arcs are moveable in a “drag and drop” style approach. Preferred features of this tool would include: —

1. Holistic and Atomistic data viewing of networks. The nodes and arcs can be moved with mouse or similar device.

2. Facilitates adding “Hunch” nodes and arcs to assess impact on the network.

3. Facilitates removing nodes and arcs to assess impact on the network.

4. A mathematical equation allows the user to be presented with predictions about the most efficient and least efficient method of fragmenting the network.

5. Bayesian Statistical Analysis.

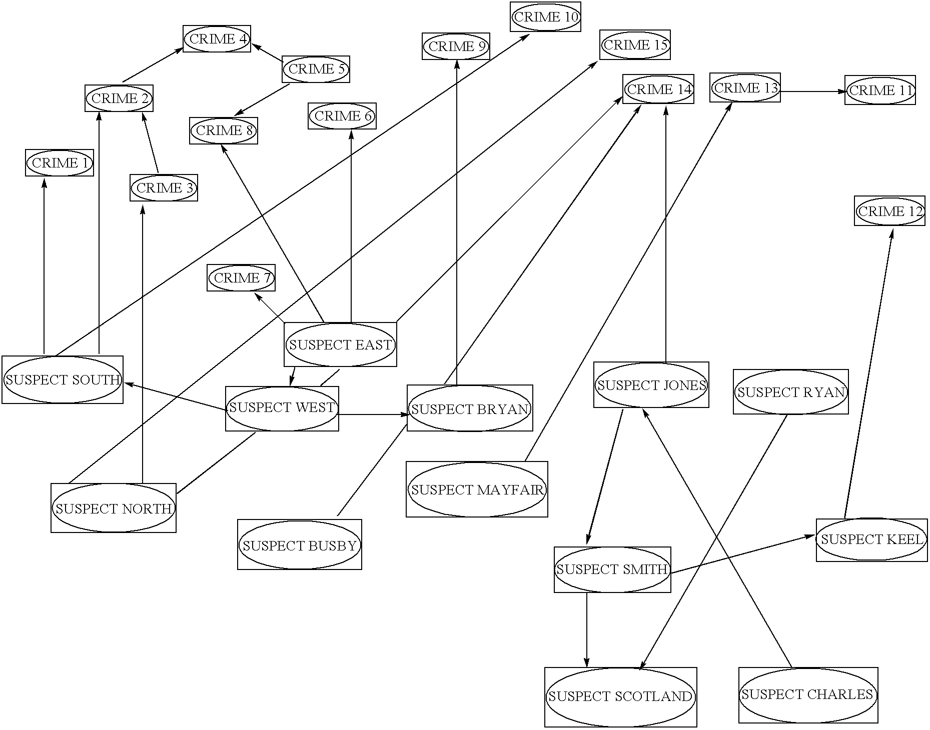

With the above described methodology and system, a preferred embodiment of the present invention, in the law enforcement context, would provide:

Management of Data

Managing the receipt, analysis and allocation of forensic matches (HITS)

Managing matches (HITS) from diverse evidence types

Provision of management information about effectiveness in gaining evidence and intelligence and matches

Communicating by printed package or digital transfer the evidence bundle (Action Package to arrest, observe, make further inquiries)

Integration, Linking, Analysis and Synthesis Tools

Access to accurate and standard form intelligence and evidence

Visualization of data

Geographical visualization of links and networks

Potential to generate new knowledge and intelligence and evidence by querying, analyzing and juxtaposing data

Identification of “series and patterns of crime”

Identification of prolific offenders

Identification of criminal attributes (demographics and personal attributes, age, sex, occupation, residence, associates, criminal background)

Identification of crime or event “hot spots”.

Identification of travelling criminals

Performance Monitoring Tools

Identification of success rates and outcomes by evidence and intelligence types and combinations of types.

Identification of success rates of personnel operating sensing devices or engaged in the collection of evidence and intelligence.

Identification of costs and yields of evidence and intelligence types and combinations of types.

Tracking Action Packages allocated to personnel.

Evaluating effectiveness of specific projects and initiatives by cost and effectiveness and success rates

Further, the above described system and methodology provides multiple benefits to the investigator that are unavailable using traditional investigational methods or systems, including:

1. Consolidation and generation ‘strong’ evidence (PROOF) of association between a particular individual and a particular crime with evidence that can withstand scrutiny. In the absence of evidence to the contrary, the links and connections discovered will usually justify the offender being charged or proceeded against.

2. Matches (HITS) that may prompt further investigation and analysis of crime and criminal databases to generate more evidence of association with outstanding crimes.

3. An integrated system that brings together multiple sources and types of evidence and information into one process and system.

4. A system that allows HITS from all sources to be handled managed and audited by one process and system.

5. A system that allows powerful search and comparison facilities between matches (HITS) and crime data to prevent duplication of effort and to report, for example, where one suspect is identified at several crime scenes by different evidence types or, where several evidence types identify the offender to one scene of crime.

Preferably, the system of the present invention described above and the embodiments which follow are configured and designed so that it can be used as an executable program on a lap top or desk top computer, and/or associated with one or more data storage areas and applications through local and wide area networking.

B. Second Illustrative Embodiment—An Investigitive System and Method of Identifying “Unknow n” Offenders

The ability to systematically (and routinely) identify “persistent offenders” has great potential for decision-making and optimizing investigative effectiveness. Identifying those persons committing most of the crime in our systems offers greater returns on investments made in the deployment of staff and financial resources. However, intelligence work has traditionally long approached the identification and elimination of suspects in a conceptually narrow way. The focus of attention has been on the use of names rather than a wider concept involving the use of ‘Indicators of Identity.’ Intelligence systems employed in law enforcement use names as the key identifier, despite the fact that many different people bear the same name. The same is true of evidence systems used in fingerprinting and other forensic databases.

In accordance with this embodiment of identifying unknown offenders, the use of a wide range of indicators of identity is used rather than narrow single indicators (typically only a name) to provide a more inquisitive and effective methodology for identification. Rather than simply referring to offenders by either their name or as simply “unknown,” they can be referred to as “virtual unknowns.” In accordance with the present invention, such virtual unknowns are classified and catalogued in a database alongside indicators of the characteristics known to the investigator. As the investigation of a crime or offense proceeds over time, and by using such multiple indicators in combination, the investigator is able to explore different combinations and different inferential chains of links to help fill in the gaps in knowledge regarding the identity of an offender. Further, researching direct and indirect chains of links may eventually produce or suggest a possible indicator as a means of identification. An example of a preferred embodiment of the invention is described below.

### EXAMPLE

An investigator is satisfied from evidence that a crime has been committed. Thus, it can be inferred that someone, who may (as yet) be unknown, committed the crime. In accordance with this embodiment of the invention, the unknown person is classified as a “virtual suspect” simply by giving him (or her) a unique number (or designation) to act as an identifier until his true identity is determined. Once all of the ‘unknowns’ have been allocated with a unique number, one can then categorize them as ‘virtual unknown’ persons, providing a unique way of approaching the problem of identification. In this preferred embodiment, multiple indicators about their characteristics, their identity and/or their personal circumstances are used to do so. Taken together, these indicators can provide the means to link different aspects of identity until any one or more of those indicators provide a suggestion of a name. By developing and considering direct and indirect chains of inference between indicators, the ability to identify and likelihood of identifying unknown offenders is enhanced.

By way of example of a preferred embodiment of this invention, reference is made to the table (spreadsheet) below, which shows a multi-dimensional identification index designed to present a systematic approach to the use of a range of indicators to identify people.

Events, Crimes
and People: 1-n

| Evidential Indicators of Identity: | 1 | 2 | 3 | 4 | 5 |
|---|---|---|---|---|---|
| 1. Sex | | | | | |
| 2. Birth Date or Age | | □ | | ▪ | |
| 3. Address Zip Code | | | | | |
| 4. E Mail Address Number | | | | | |
| 5. Fathers Reference Number | | | | | |
| 6. Mothers Reference Number | | | | | |
| 7. Male Siblings | | | | | |
| 8. Female Siblings | | | | | |
| 9. Height | | | | | |
| 10. Eye Color | | | | | |
| 11. Hair Color | | □ | | ▪ | |
| 12. Ethnic Origin | | □ | | ▪ | |
| 13. Shoe Size | | | | | |
| 14. Biometric Identifiers: | | | | | |
| (a) Eyes | | | | | |
| (b) Facial | | | | | |
| (c) Fingerprints (10) | | | | | |
| 15. DNA Profile | | ▪ | | ▪ | |
| 16. Genetic Characteristics: | | □ | | □ | |
| (a) Hair Color | | □ | | □ | |
| (b) Eye Color | | □ | | □ | |
| (c) Gender | | □ | | □ | |
| (d) Ethnic Ancestry | | □ | | □ | |
| (e) Height | | □ | | □ | |
| 17. Body Marks; Tattoo/Scars | | □ | | ▪ | |
| 18. Vehicle Number | | | | | |
| 19. Electoral Role Number | | | | | |
| 20. Nationality | | | | | |
| 21. Passport Number | | | | | |
| 22. National Insurance Number | | | | | |
| 23. Driving License Number | | | | | |
| 24. Credit Card Number | | | | | |
| 25. Taxation Number | | | | | |
| 26. Telephone Number | | | | | |
| 27. Cell Phone Number | | | | | |
| 28. National Identification No. | | | | | |
| 29. Associates with | | | | | |
| 30. Employed By | | | | | |
| 31. Educated at | | | | | |
| 32. Related to | | | | | |
| 33. Criminal Convictions | | | | | |
| 34. Occupation | | | | | |
| 35. [symbol] | | | | | |

To illustrate the effectiveness and application of this system, let us assume that Event 2 was a burglary where the offender shed hair and that subsequent DNA analysis produced a profile. However, let us also assume that no reference sample of the offender existed on the National DNA Database and that, therefore, the offender cannot be immediately identified by name. Based on available genetic analyses and procedures, genetic information gained from DNA Profiling the hair realized further information about the person's physical characteristics; hair Color, eye Color, ethnic ancestry and height. These additional indicators are used to begin to fill gaps in the ‘Virtual Persons Record’ represented by the cells in the spreadsheet, some of which may become useful in ultimately identifying the offender.

Taking this example a step further, let us assume that the same DNA profile is found at Event 4, a theft of a motor vehicle. A witness to Event 4 states that the offender was seen to have a distinctive tattoo on his right forearm of an eagle and sword. He was aged between 30 and 40 years, white European and had brown to red hair.

Because Event 4 revealed the same DNA profile as Event 2, we can begin to cross reference specific details of ‘Indicators’ from Event 4 to Event 2. For example, the original Indicators (DNA, Tattoo, Age and Hair Color) discovered from Event 4 are marked with a shaded square (▪) sign. Because the same DNA profile was found at Event 2 and 4, it can be inferred that all details for Event 4 should apply to Event 2. Those inferred Indicators are marked with an unshaded square (□).

In this example, it can be seen how a computer-based Index (or spreadsheet) of the type shown above can be used in a method of cross referencing evidence from one event to another event to provide a system to navigate inferential links gaining clues to the identification of individuals and even groups of individuals. In this example, it can be seen that the DNA recovered in Event 2 and 4 provided genetic information about the physical characteristics and ancestral ethnicity and these become a part of the index.

Taking the example shown in the Index a step further, a search of the tattoo file in the ‘Multi-Dimensional Index’ reveals that two people are known to have a tattoo of this description; a male aged 65 years of West Indian appearance with a recorded name of Charles and a 32 year old male of White European appearance called Finney. Neither had previously provided DNA profiles. In a preferred embodiment of the invention, the system is automated to check for those persons within the population with indicators that match a tattoo as well as any other indicators available. This narrows down those in the system that could match with the information available.

In order to maximize the effectiveness of the methodology described herein, it is preferred that a computer or network of computers be used to manage and track chains of connections produced by the above described cross-referencing. Although the methodology is simple, the potential links involved soon become complex and require an efficient means of tracking and cross-referencing. Another useful attribute of the preferred methodology and system is that the indicators of identity can be searched in pre-determined ways involving one indicator or a combination of indicators to ‘cleave out’ of the system configurations of information of interest to the investigator. For example, an investigator may need to identify a white male, aged 50-55 years, brown hair, blue eyes and drives a white BMW car. This may produce a range of potential suspects. Some with legal names and some still classified as ‘Virtual Unknowns.’ Again, the process of cross referencing indicators, combining indicators and exploring inferential routes between records may produce an indicator of interest in determining a true identity.

Another aspect to this invention is the ability to identify links between two or more offenders. The subject methodology does not assume that the ‘Virtual Suspect or Offender’ was alone when the crimes were committed; they may have committed any one or any combination of these crimes with any number of other individuals. The Index may provide evidence of links between individuals and hence their potential identity. Even the notion of ‘Virtual Criminal Networks’ can be used in this way. For example, evidence in the database may suggest that a number of crimes have been committed and, by a range of indirectly linked indicators, a complex network of links between a group of people may be suggested. These groups can be used as sources of suggested names for elimination purposes. As with the fingerprint evidence at burglary 4 discussed in the example, if we one can establish an accomplice of our ‘Virtual Offender’ acting in concert at another burglary (e.g., burglary 6), that evidence (whatever it may be) may suggest a potential name for the donor of the DNA found at each of the 10 burglary crimes.

C. Third Illustrative Embodiment—Airport Security Application

There is a need for a system and methodology that improves the ability to identify potential threats to airline security. Described below is a preferred system and methodology of managing, analyzing, linking and displaying information designed to enhance the ability to persons who pose potential security risks.

MULTI-DIMENSIONAL APPROACH TO IDENTIFICATION
A New System Module for Airline Security

Events/People

| | | | | | |
|---|---|---|---|---|---|
| Evidential Indicators of Identity; | 1 | 2 | 3 | 4 | 5 |

```
36. Sex
37. Birth Date or Age
38. Address Zip Code
39. E Mail Address Number
40. Fathers Reference Number
41. Mothers Reference Number
42. Male Siblings
43. Female Siblings
44. Height
45. Eye Color
46. Hair Color
47. Ethnic Origin
48. Shoe Size
49. Biometric Identifiers:
    (a) Eyes
    (b) Facial
    (c) Fingerprints (10)
50. DNA Profile
51. Genetic Characteristics:
    (a) Hair Color
    (b) Eye Color
    (c) Gender
    (d) Ethnic Ancestry
    (e) Height
52. Body Marks; Tattoo/Scars
53. Vehicle Number
54. Electoral Role Number
55. Nationality
56. Passport Number
57. National Insurance Number
58. Driving License Number
59. Credit Card Number
60. Taxation Number
61. Telephone Number
62. Cell Phone Number
63. National Identification No.
64. Associates with
65. Employed By
66. Educated at
67. Related to
68. Criminal Convictions
69. Occupation
70. Traveled From:
71. Traveled To:
72. Airline Company
73. Hire Car reference
74. Hotel reference
75. Immigration Number
76. [symbol]
```

The spreadsheet above provides an illustration of a method of identifying people (and potential security risks) by use of a range of ‘indicators of identity.’ Instead of using just a name, a passport number or other formal references, other types of information that assist in identifying individuals are indexed in the table or spreadsheet. The combination of these indicators of identity provides the basis for a better and more intelligent approach to identity. Although, it is desirable to identify people by name eventually, as long as they can be uniquely identified in the first instance with a range of indicators, it enhances the likelihood of identifying and authenticating their true identity. In most cases, this will be easy and straight-forward. But in others, people will try subterfuge and trickery to beat the system.

Referring to the table above, note that the name appears at the bottom of the list. This demonstrates that the identification of the name and linking it with a proven person is the ultimate aim. Theoretically, it is possible to complete all of the spaces in the table, at other times only a few will be completed. But, as the individual travels more often, more information can be stored and available for cross-referencing and checking. Preferably, much of the information will be collected as part of the ticket and security process itself. The most important features of the system for airline security will be:—

1. The speedy identification of passengers by a range of indicators

2. A means of authenticating the identification by comparing, cross-referencing and linking indicators.

3. A means of backtracking and identifying those persons whom may have tried to circumvent the system. (For example, someone using a false passport, a stolen credit card, in possession of suspicious luggage etc.) Knowing who they may be and whom they have traveled with previously may provide vital information.

The table above is a ‘Multi-Dimensional Identification Index’ designed to present a systematic approach to the use of a range of indicators to identify people. Preferably, a computer or networks of computers are used to manage and track chains of connections produced by this cross-referencing approach. Although the methodology is simple, the potential links involved soon become complex and require an efficient means of tracking and cross referencing. The ultimate goal of the present system and method is to eventually establish an identity using the conventional method of a legal name or at the least reduce the uncertainty about the legal identity of the person of interest. The methodology and system in this embodiment operates under the same principles and theories discussed in connection with the Second Embodiment disclosed herein.

As with the Second Embodiment, another attribute of using this method is that the indicators of identity can be searched in pre-determined ways involving one indicator or, a combination of indicators, to ‘cleave out’ of the system configurations of information of interest to us. For example, an investigator may need to identify a white male, aged 50-55 years, brown hair, blue eyes who traveled between Boston and New York on Fridays on several occasions. The system shown and described above will provide methods of identifying him. Further, it is known that some people travelling will have proven legal names and some may be classified as ‘Virtual Unknowns.’ Again, the process of cross referencing indicators, combining indicators and exploring inferential links between records may produce an indicator of interest in determining a true identity.

Another aspect of this embodiment of the invention is that it is not assumed that a ‘Virtual Person’ was alone when travelling. He may have traveled with others and such information may be used to identify the person of interest. Even the notion of ‘Virtual Travelers Networks’ can be used in this way. These groups and indicators can be used as sources of suggested names and identifications when anomalies occur in the system.

A list of structured questions which are of regular interest to users of the system, will provide the query mechanisms. For example, algorithms to determine the answers to questions such as the following may be included in a computerized system employing this methodology:

Show me the names or records, in alphabetical order if possible, of those persons who traveled between ‘X’ and ‘Y’ on (or between) the following dates.

Show me the names or records, in alphabetical order if possible, of those who have traveled with false documents.

Show me the names or records, in alphabetical order if possible, of those who have traveled in company with the names or records, of ‘Z.’

There are many other structured questions that can be in-built to the system. Preferably, such inquiries should be part of an automated and linked system to visually display the results of the intelligence exercise. Linking people, travel times, dates, locations, documents and other travelers, will aid the intelligence process for identification, authentication and tracking.

While the methodology and system of the present invention has been exemplified in the context of law enforcement and airline security applications, there are numerous other areas to which the subject system and methodology have application, including but not limited to:—

1. The management, analysis, synthesis of data dealing with Credit card fraud.

2. The management, analysis, synthesis of data dealing with Taxation fraud.

3. The management, analysis, synthesis of data dealing with Insurance fraud.

4. The management, analysis, synthesis of data dealing with Government Social and Subsistence Benefits.

5. The management, analysis, synthesis of data dealing with Government Grants To Persons and Legal Bodies.

6. The management, analysis, synthesis of data dealing with for Company Directorships.

7. The management, analysis, synthesis of data dealing with Animal Ancestry (Horse Pedigree and Ownership).

8. The management, analysis, synthesis of data dealing with Airline Passenger Lists.

9. The management, analysis, synthesis of data dealing with Credit (Card) Transactions.

10. The management, analysis, synthesis of data dealing with Court Judgements.

11. The management, analysis, synthesis of data dealing with Drugs Networks. 12. The management, analysis, synthesis of data dealing with epidemiology.

13. The management, analysis, synthesis of data dealing with telephone billing data.

14. The management, analysis, synthesis of data dealing with loan and credit applications.

Although several embodiment of the invention has been illustrated in the accompanying drawings and described in the foregoing Detailed Description, it must be understood that the invention is not limited to the embodiments disclosed but is capable of numerous rearrangements, modifications and substitutions without departing from the scope of the invention.

We claim:

1. A method of evidence management comprising the steps of:
(a) inputting a multiple of independent evidentiary links,
(b) identifying a relationship between at least one of said multiple of independent evidentiary links and an event; and
(c) displaying said relationship.

2. A method as recited in claim 1, wherein said step (a) includes a multiple of forensic sources.

3. A method as recited in claim 1, wherein said step (b) includes a criminal event.

4. A method as recited in claim 1, wherein said step (c) includes displaying a pattern of the said relationships.
